(19) United States
(12) Patent Application Publication
(10) Pub. No.: US 2021/0178517 A1
(43) Pub. Date: Jun. 17, 2021

(54) Laser Apparatus With Synchronous Light Path Delay

(71) Applicant: Superbin Company, Ltd., Taipei City (TW)

(72) Inventor: Yen-Mu Chen, Taipei City (TW)

(21) Appl. No.: 17/038,295

(22) Filed: Sep. 30, 2020

(30) Foreign Application Priority Data
Dec. 13, 2019 (TW) 108145783

(51) Int. Cl. B23K 26/08; B23K 26/06; B23K 26/03

(52) U.S. Cl. CPC B23K 26/0892; B23K 26/0884; B23K 26/032; B23K 26/0665; B23K 26/0643

(57) ABSTRACT

A laser apparatus with synchronous light path delay comprises a laser path adjustment unit and a gantry-type machine. The gantry-type machine drives a machining head to move two-dimensionally or three-dimensionally which will induce a light path length change defined by the total moving distance of the machining head. The laser path adjustment unit synchronously adjusts the traveling distance of a laser beam traveling to the machining head according to the total moving distance of the machining head. In this way, the focus spot size of the laser beam inputted from the machining head remains unchanged and the focus spot remains on a flat surface.

This application claims the priority benefit of Taiwan patent application number 108145783 filed on Dec. 13, 2019.

### FIELD OF THE INVENTION

The present invention relates to the field of laser and in particular to a laser apparatus with the adjustment of the laser light path.

### BACKGROUND OF THE INVENTION

The traditional laser machining machine such as the gantry-type laser machining machine uses a moving mechanism like a gantry-type mechanism to move a laser machining head two-dimensionally to be aligned with a fixed workpiece under the laser machining head for laser machining. However, this traditional technique will cause the change of the traveling distance of the laser beam traveling from the laser source to the laser machining head. Consequently, the focus of the laser beam emitted from the laser machining head cannot be kept focusing on the surface of the workpiece or the laser beam arriving on the surface of the workpiece has an uneven spot size. Therefore, the different effects of the machining are incurred.

As for another traditional laser machining machine, the laser machining head is disposed above and aligned with the workpiece on the platform at a fixed height. The platform is driven to move two-dimensionally under the laser machining head in which the laser machining head is held still to keep the laser beam to focus on the surface of the workpiece. However, this traditional machine requires a large footprint, which is not proper for the machining requirements in a small space.

How to provide a stable laser beam suitable for the current gantry-type laser machining machine to machine the workpiece is the target which the inventor and the people in this field want to achieve.

### SUMMARY OF THE INVENTION

One objective of the present invention is to provide a laser apparatus with light path delay which can synchronously adjust the light path. The laser apparatus has a laser path adjustment unit which can synchronously adjust the delay distance of the light path to compensate the total moving distance of the machining head such that the focusing condition is maintained during the movement of the machining head.

Another objective of the present invention is to provide a laser apparatus with light path delay which can be separated into two parts, the first bed and the second bed, for installation. The gantry-type machine is installed on the first bed and the laser path adjustment unit of the laser source is installed on the second bed. Besides, different laser sources can be installed on the second bed depending on different workpiece materials and machining requirements to meet the customized demand of various laser machining.

Yet another objective of the present invention is to provide a laser apparatus with light path delay in which the gantry-type machine and the laser path adjustment unit can both be installed on a single bed to meet the requirement of a compact or limited space.

To achieve the above objectives, the present invention provides laser apparatus with synchronous light path delay, which comprises a gantry-type machine, a source reflection assembly, and a laser path adjustment unit. The gantry-type machine has a first moving module and a second moving module movably connected to the first moving module. The second moving module is provided with a moving reflector disposed corresponding to a machining head. The machining head moves with the first moving module and the second moving module. The source reflection assembly is disposed corresponding to the moving reflector. The laser path adjustment unit has a laser source and a light path adjustment module. The light path adjustment module is disposed corresponding to the source reflection assembly. The laser source emits a laser beam which goes through the light path adjustment module and the source reflection assembly, then, travels to the machining head through the moving reflector. The light path adjustment module has a guiding part and a return reflection assembly. The return reflection assembly moves synchronously with the machining head and reciprocates on the guiding part over an adjustment distance to match the movement of the machining head.

The above-mentioned first moving module is an X-direction moving module; the second moving module is a Y-direction moving module.

The above-mentioned machining head has a third moving module which is movably connected to the second moving module; the third moving module is a Z-direction moving module.

The above-mentioned machining head has a beam input end, at least one beam output end, and a switch device. At least one beam output end comprises a first beam output end and a second beam output end.

The above-mentioned source reflection assembly comprises a first reflector, a second reflector, and a third reflector. The first reflector is disposed corresponding to the laser source and the second reflector. The second reflector and the third reflector are disposed corresponding to the return reflection assembly. The third reflector is disposed corresponding to the moving reflector.

The above-mentioned return refection assembly, the first reflector, the second reflector, and the third reflector are reflecting mirrors.

The above-mentioned gantry-type machine and the laser path adjustment unit are connected to a control unit.

The above-mentioned total moving distance of the machining head, which is defined by the movements of the first moving module and the second moving module; where as the adjustment distance is half of the total moving distance of the machining head.

The above-mentioned total moving distance of the machining head, which is defined by the movements of the first moving module, the second moving module, and the third moving module; where as the adjustment distance is half of the total moving distance of the machining head.

### BRIEF DESCRIPTION OF DRAWING

The following drawings are used to make the present invention more easily to be understood; they will be detailed in the description and constitute part of the embodiments. By means of the embodiments in the description accompanied with the corresponding drawings, the embodiments of the present invention and the theory of operation thereof can be explained in detail.

FIG. 1 is a schematic view of the separate installations of the gantry-type machine and the laser path adjustment unit of the present invention;

FIG. 2 is a cross-sectional view of FIG. 1;

FIG. 3 is a schematic view of the gantry-type machine and the laser path adjustment unit of the present invention connected to a control unit;

FIGS. 4A-4E are top views of the various operating positions of the present invention;

FIG. 5 is a schematic view of the laser beam focusing on an object surface as the machining head is moving; and

FIGS. 6A and 6B are schematic views of the various operating positions according to another embodiment of the present invention.

### DETAILED DESCRIPTION OF THE INVENTION

The objectives above for the present invention, the features of structure, and function of the present invention are described according to preferred embodiments in accompanying figures.

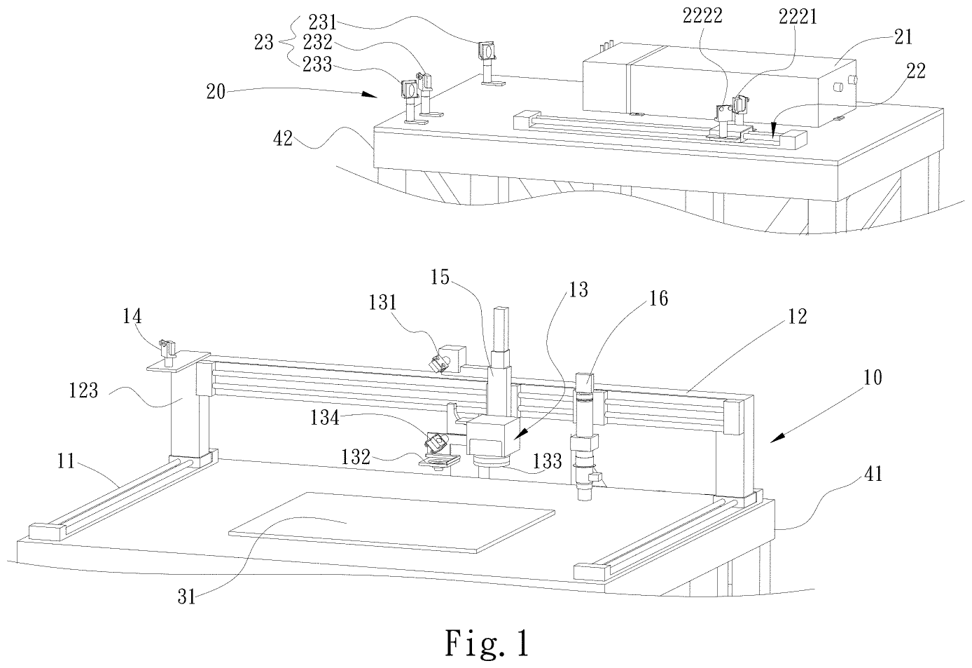

FIG. 1 is a schematic view of the separate installations of the gantry-type machine and the laser path adjustment unit of the present invention. The laser apparatus, shown in FIG. 1, comprises a gantry-type machine 10 and a laser path adjustment unit 20. The gantry-type machine 10 and the laser path adjustment unit 20 are independent units and can be installed separately. The gantry-type machine 10 is installed on the first bed 41; the laser path adjustment unit 20 and the laser source 21 thereof are installed on the second bed 42. Therefore, when different workpiece materials and different machining conditions are required, different laser sources can be used. Then, the size of the second bed 42 can be changed to adapt for the volume of the laser source. Also, it is convenient to replace different laser sources 21. However, the configuration is not limited to the previous one. When the working space is confined, the gantry-type machine 10 and the laser path adjustment unit 20 both can be installed on a single bed. Either of the first bed 41 and the second bed 42 can be a fixed or moveable bed or both can be fixed or moveable beds.

The above-mentioned gantry-type machine 10 has a first moving module 11 and a second moving module 12 movably connected to the first moving module 11. The second moving module 12 has a moving reflector 14. The third moving module 15 is movably connected to the second moving module 12 and is provided with a machining head 13. In this configuration, the machining head 13 can move two-dimensionally (in the X-Y direction) or three-dimensionally (in the X-Y-Z direction). In another embodiment, the third moving module 15 can be omitted for simple machining or cost reduction. For example, the machining head 13 can be movably connected to the second moving module 12 through a slider such that the machining head 13 can move two-dimensionally (in the X-Y direction).

The above-mentioned first moving module 11, for example, is an X-direction moving module. The second moving module 12 such as a Y-direction moving module is supported and connected to the first moving module 11 through two posts 1123. The third moving module 15, for example, is a Z-direction moving module. In the current embodiment, the first, the second, and the third moving modules 11, 12, 15, are, for example, a linear guideway, a slider, and a driving motor, respectively.

In the current embodiment, the moving reflector 14 is disposed corresponding to the machining head 13 of the third moving module 15. The machining head 13 is disposed at a height in the Z-direction above and is aligned with the workpiece 31. In some embodiments, the height of the machining head 13 in the Z-direction is adjusted through the third moving module 15. Besides, the machining head 13 has a beam input end 131 (like a reflecting mirror), at least one beam output end, and a switch device 134 (like a reflecting mirror). As shown in FIG. 1, the machining head 13 comprises a first beam output end 132 and a second beam output end 133, but not limited to this. More beam output ends can be installed according to the machining requirements. In the current embodiment, the first beam output end 132 is formed by a focusing lens, for example. The second beam output end 133 is formed by a galvanometer, for example. Thus, the laser beam passing through the beam input end 131 is output from the first beam output end 132 or from the second beam output end 133, controlled by the switch device 134.

Moreover, the vision module 16 is movably connected to the second moving module 12 through a slider. The vision module 16 comprises a microscope and a light source to visibly display the surface of the workpiece 31.

When the gantry-type machine 10 moves, two posts 123 of the second moving module 12 move in the X-direction on the first moving module 11; the third moving module 15 carries the machining head 13 and moves along the second movable module 12 and in the Y-direction. In addition, the height of the machining head 13 in the Z-direction is kept or adjusted through the third moving module 15. In this way, the total moving distance of the machining head 133, which is defined by the movement of the first moving module 11 and the second moving module 12 or defined by the first moving module 11, the second moving module 12, and the third moving module 15.

The laser path adjustment unit 20 has a laser source 21, a light path adjustment module 22, and a source reflection assembly 23. The laser source 21 is used to emit a laser beam. The source reflection assembly 23 comprises a first reflector 231, a second reflector 232, and a third reflector 233. The light path adjustment module 22 has a guiding part 221 (e.g. a linear guideway or a slider) and a return reflection assembly 2221, 2222. The return reflection assembly 2221, 2222 reciprocates on the guiding part 221 through the slider.

The above-mentioned first reflector 231 is disposed corresponding to the laser source 21 and the second reflector 232; the second reflector 232 and the third reflector 233 are disposed corresponding to the return reflection assembly 2221, 2222; the third reflector 233 is disposed corresponding to the moving reflector 14. Consequently, the optical path length (OPL) of the laser beam travelling from the laser source 21 to the first beam output end 132 or to the second beam output end 133 is formed.

Therefore, the emitted laser beam travels from the first reflector 231 to the second reflector 232, then from the second reflector 232 to the return reflection assembly 2221, 2222, then from the return reflection assembly 2221, 2222 to the third reflector 233. After that, the laser beam travels from the third reflector 233 to the moving reflector 14, then from the moving reflector 14 to the beam input end 131 of the machining head 13. Finally, the laser beam is selected to be output from the first beam output end 132 or from the second beam output end 133 of the machining head 13.

Furthermore, the return reflection assembly 2221, 2222 move with the machining head 13 synchronously and reciprocates on the guiding part 221 over an adjustment distance to match the moving distance of the machining head 13 such that the traveling distance of the laser beam that travels from the laser source 21 to the first beam output end 132 or to the second beam output end 133 remains fixed, which further prevents an insufficient traveling distance of the laser beam because of the change of the light path caused by the movement of the machining head 13.

It should be explained that the laser beam travels from the second reflector 232 to the return reflection assembly 2221, 2222 and then travels from the return reflection assembly 2221, 2222 to the third reflector 233, which forms two parallel light paths. That is, the laser beam forms a dual light path in the light path adjustment module 22. Therefore, the adjustment distance of the laser path adjustment unit 20 is half of the total moving distance of the machining head. For example, when the total moving distance of the machining head is L, the adjustment distance is ½ L. The total light path of the laser beam is the sum of the total moving distance of the machining head L and the adjustment distance ½ L.

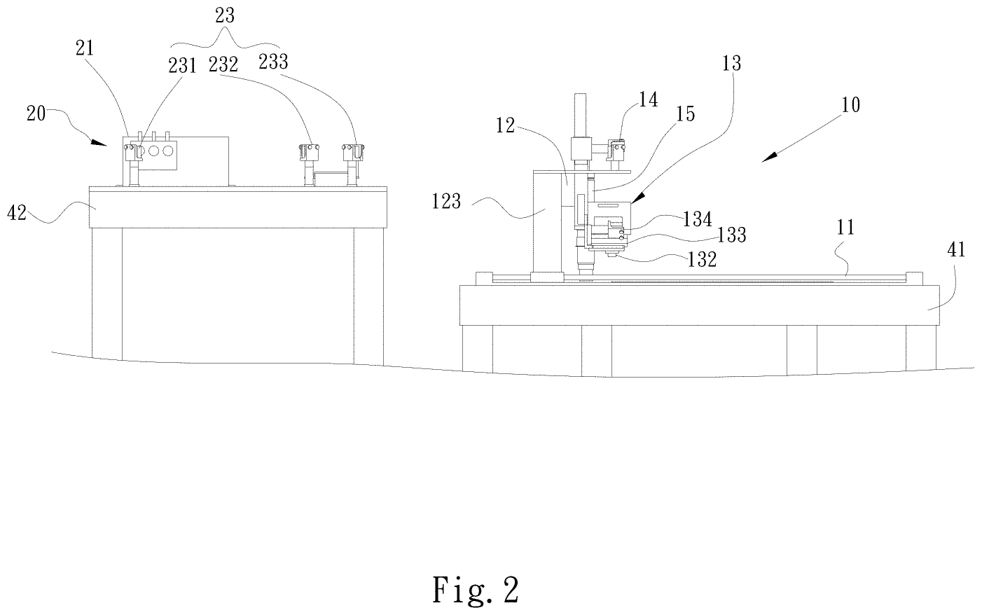

Please continue to refer to FIG. 2. In the current embodiment, the moving reflector 14 and the third reflector 233 of the source reflection assembly 23 are parallel with the X-direction of the gantry-type machine 10 such that the laser beam can travel to the machining head 13 of the gantry-type machine 10 along a proper light path. The return reflectors 2221, 2222, the first reflector 231, the second reflector 232, and the third reflector 233, for example, can be reflecting mirrors, but not limited to this. In other embodiments, the laser path adjustment unit 20 can be disposed below or above the first bed 41 of the gantry-type machine 10; a light path of the laser beam can be formed by the configuration of the source reflection assembly 23 that is disposed corresponding to the laser source 21 and the moving reflector 14, respectively.

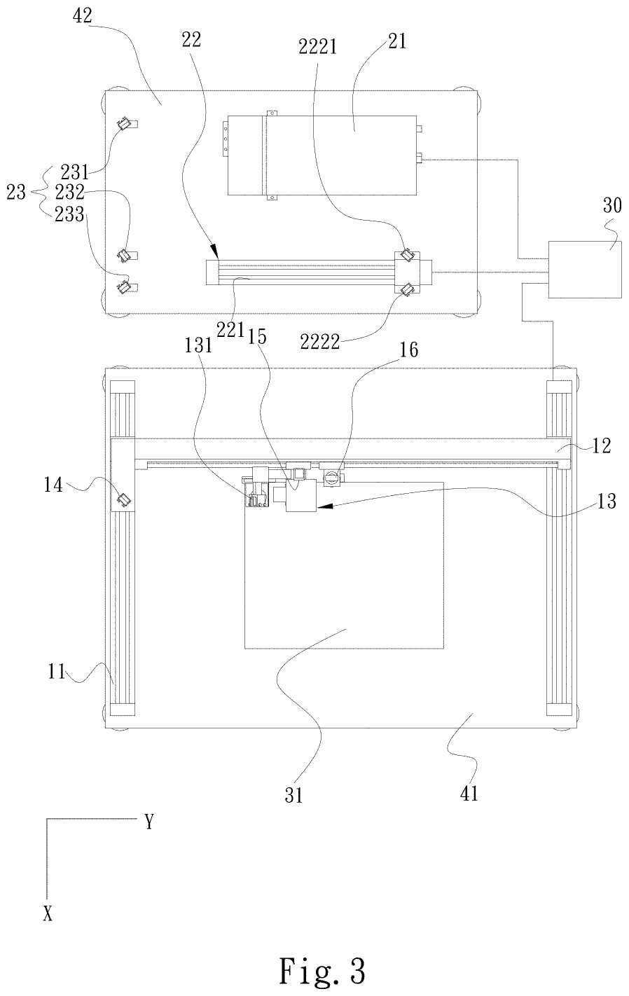

Please continue to refer to FIG. 3. In an embodiment, the gantry-type machine 10 and the laser path adjustment unit 20 are connected to a control unit 30. The control unit 30 controls the machining head 13 of the gantry-type machine 10 and the return reflection assembly 2221, 2222 of the laser path adjustment unit 20 to move synchronously and controls the laser source 21 to emit a laser beam. In more detail, the control unit 30 controls the total moving distance of the machining head 13 and the adjustment distance of the return reflection assembly 2221, 2222 according to the total moving distance of the machining head such that the gantry-type machine 10 and the laser path adjustment unit 20 move synchronously.

An example is given below to explain how the gantry-type machine 10 and the laser path adjustment unit 20 move synchronously. Also, several relative positions between the machining head 13 and the workpiece 31 are illustrated. For easy understanding, the following example shows the laser beam travels through the first beam output end 132 of the machining head 13. Besides, the scales, the coordinates, and the relative positions shown in the following examples are not to limit the scope of the claims of the present invention.

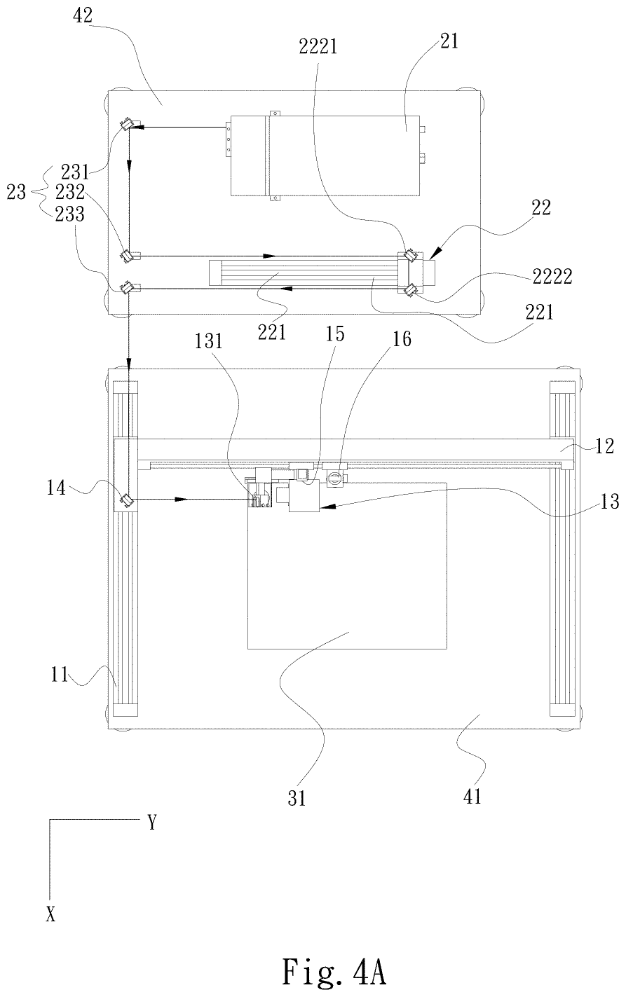

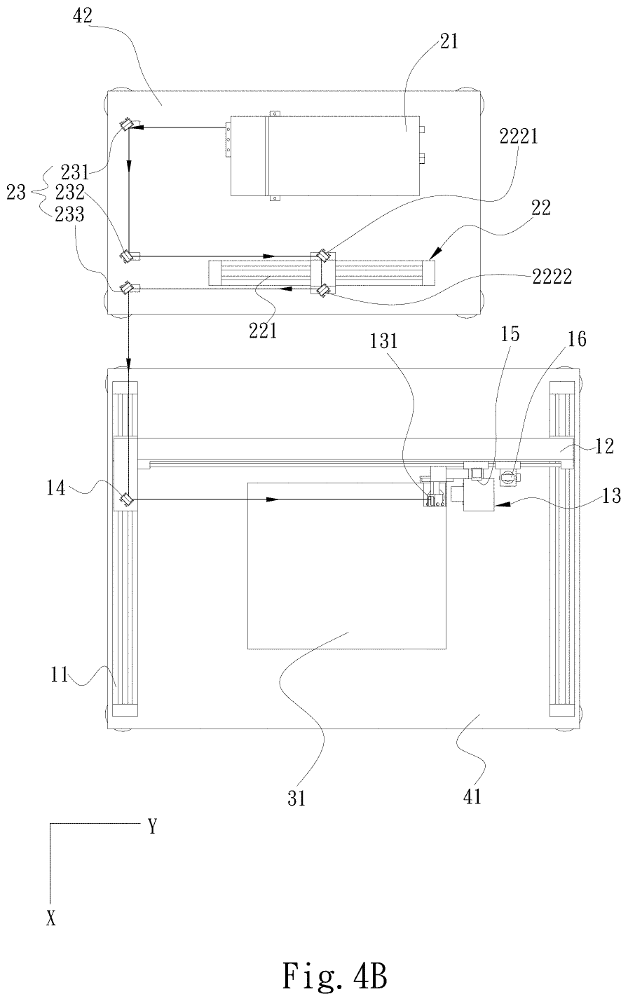

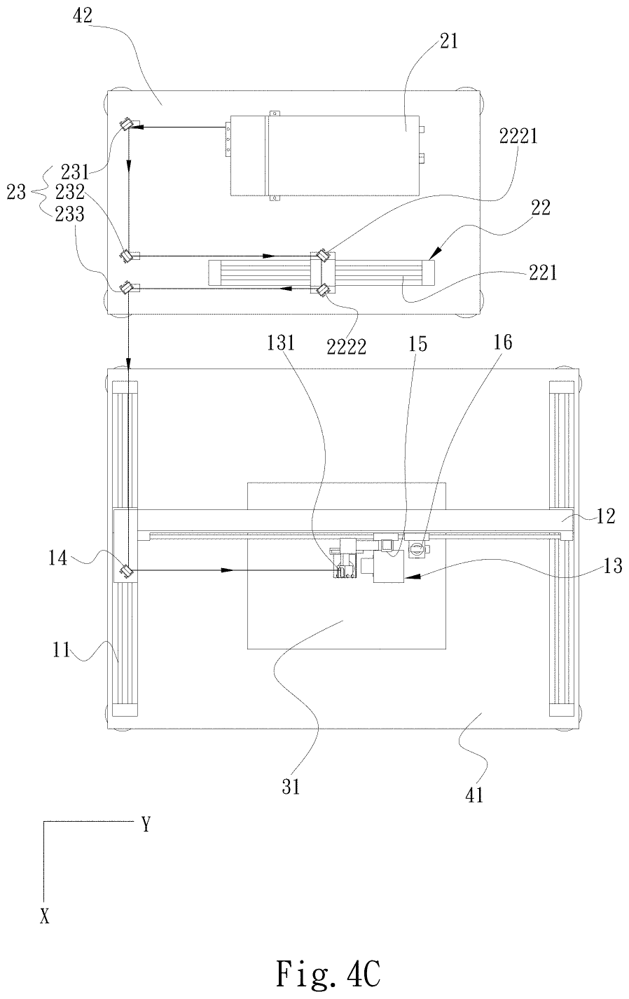

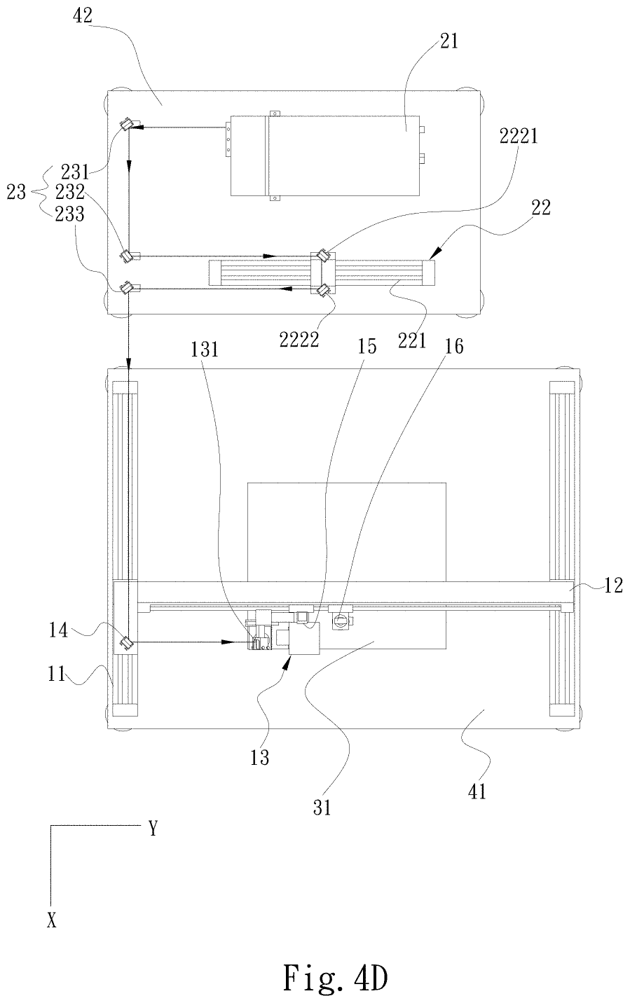

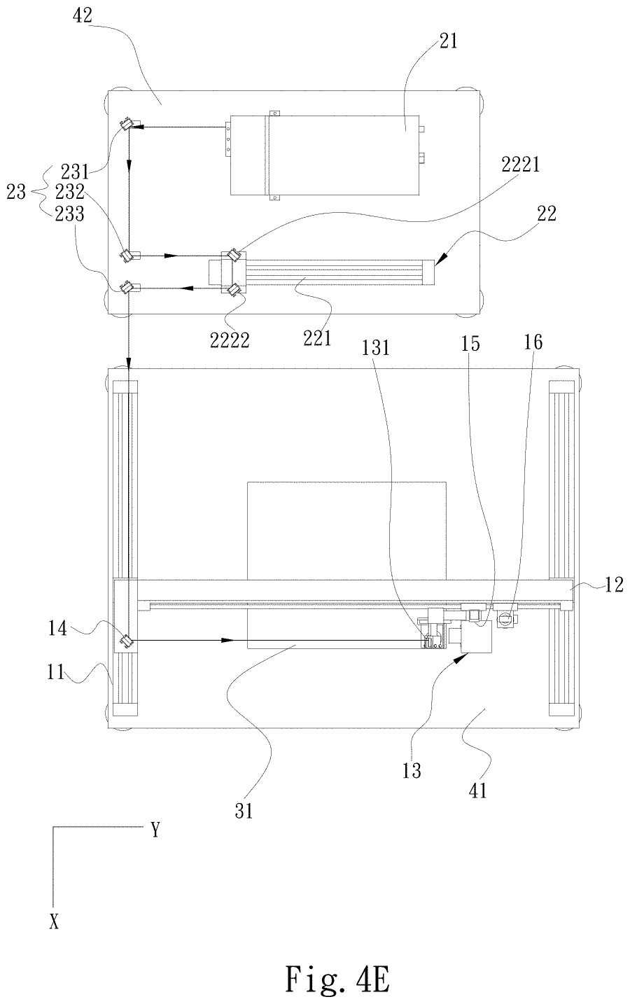

FIGS. 4A-4E are top views of the various operating positions of the present invention. As shown in these figures and FIG. 1, the workpiece 31 has a length of 200 mm and a width of 200 mm, for example. The linear movement range of the light path adjustment module 22 is 200 mm. When the machining head 13 is at the initial position, the upper left corner of the workpiece 31 on the coordinate of X=0, Y=0, Z=0 (i.e, the machining head 13 is kept at a height in the Z-direction, the same hereinafter), it means that the total moving distance of the machining head is 0. The return reflection assembly 2221, 2222 of the light path adjustment module 22 are at the rightmost of the guiding part 221, which means the adjustment distance is 0 (refer to FIG. 4A).

Further, when the machining head 13 moves rightward and arrived at the upper right corner of the workpiece 31 on the coordinate of X=0, Y=200 mm, Z=0, it means that the total moving distance of the machining head is 200 mm; the adjustment distance is 100 mm leftwards. The return reflection assembly 2221, 2222 arrive at the center of the guiding part 221 (refer to FIG. 4B).

In addition, when the machining head 13 moves from the initial position (i.e., X=0, Y=0, Z=0) to the center of the workpiece 31 (i.e., X=100 mm, Y=100 mm, Z=0), it indicates that the total moving distance of the machining head is 200 mm; the adjustment distance is 100 mm leftwards. The return reflection assembly 2221, 2222 move from the rightmost of the guiding part 221 and arrive at the center of the guiding part 221 (refer to FIG. 4C).

Besides, when the machining head 13 moves from the initial position (i.e., X=0, Y=0, Z=0) to the lower left corner of the workpiece 31 (i.e., X=200 mm, Y=0, Z=0), it indicates that the total moving distance of the machining head is 200 mm; the adjustment distance is 100 mm leftwards. The return reflection assembly 2221, 2222 move from the rightmost of the guiding part 221 and arrive at the center of the guiding part 221 (refer to FIG. 4D).

Moreover, when the machining head 13 moves from the initial position (i.e., X=0, Y=0, Z=0) to the lower right corner of the workpiece 31 (i.e., X=200 mm, Y=200 mm, Z=0), it indicates that the total moving distance of the machining head is 400 mm; the adjustment distance is 200 mm leftwards. The return reflection assembly 2221, 2222 move from the rightmost of the guiding part 221 and arrive at the leftmost of the guiding part 221 (refer to FIG. 4E).

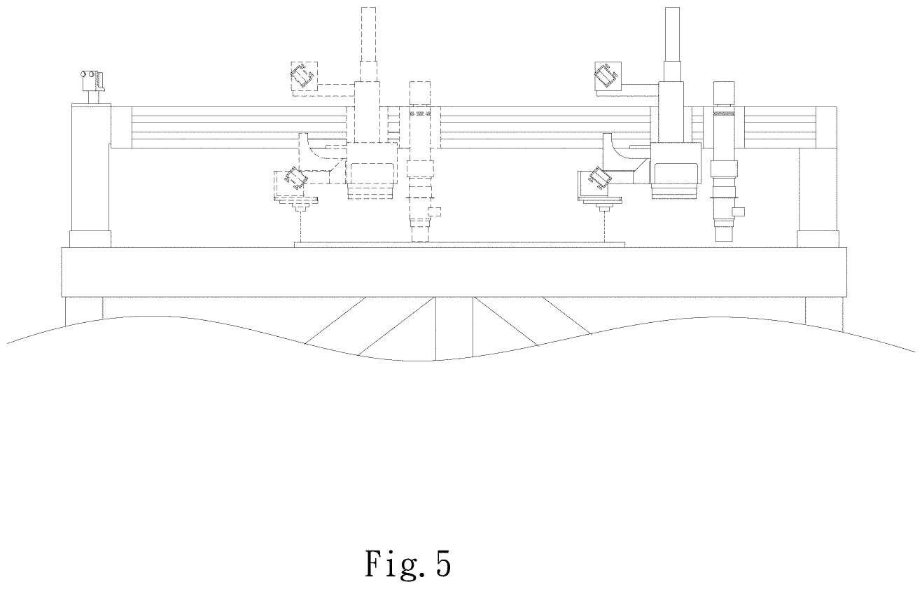

FIG. 5 is a schematic view of the laser beam focusing on an object surface as the machining head 13 is moving. The traveling distance of the laser beam emitted from the laser source 21 to the machining head 13 is maintained through the adjustment distance of the laser path adjustment unit 20 when the machining head 13 is moving. In this way, wherever the machining head 13 moves to the workpiece 31, the laser beam outputted through the first beam output end 132 of the machining head 13 can focus on the surface of the workpiece 31 stably, which further obtains consistent cutting edges and facilitates the precision machining.

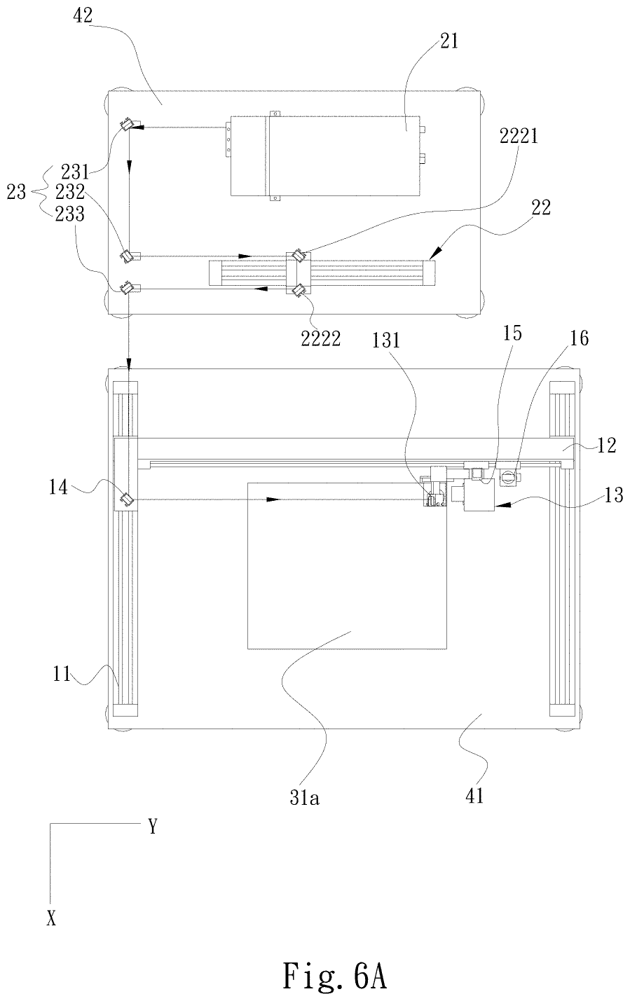

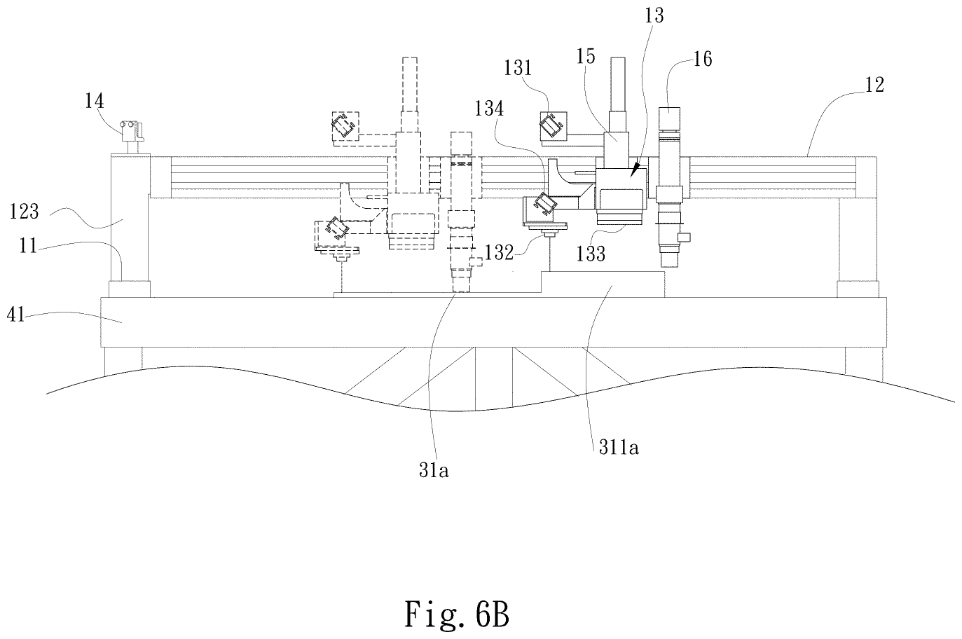

As shown in FIGS. 6A and 6B, in another embodiment, a protrusion 311a protruding from the surface of the workpiece 31a forms a high surface and a low surface on the workpiece 31a. For example, the high surface is roughly 20 mm higher than the low surface, but not limited to this. When moving to the upper right corner of the workpiece 31, the machining head 13 meets the high surface, the machining head 13 will be adjusted and raised 20 mm in the Z-direction to the coordinate of X=0, Y=200 mm, Z=20 mm through the third moving module 15. Thus, the total moving distance of the machining head is 220 mm. Meanwhile, the adjustment distance is 110 mm leftwards. The return reflection assembly 2221, 2222 move to the left of the center of the guiding part 221.

The above description has detailed the present invention. However, the above-mentioned embodiments are only preferred ones and do not limit the scope of the present invention. The scope of the present invention should be embraced by the accompanying claims and includes all the equivalent modifications and not be limited to the previous description.

What is claimed is:

1. A laser apparatus with synchronous light path delay, comprising:
a gantry-type machine having a first moving module and a second moving module movably connected to the first moving module, wherein the second moving module is provided with a moving reflector disposed corresponding to a machining head, wherein the machining head moves with the first moving module and the second moving module;
a source reflection assembly disposed corresponding to the moving reflector; and
a laser path adjustment unit having a laser source and a light path adjustment module, wherein the light path adjustment module is disposed corresponding to the source reflection assembly, wherein the laser source emits a laser beam which is reflected by the light path adjustment module and the source reflection assembly and travels to the machining head through the moving reflector, wherein the light path adjustment module has a guiding part and a return reflection assembly, wherein the return reflection assembly moves with the machining head synchronously and reciprocates on the guiding part over an adjustment distance to match the movement of the machining head.

2. The laser apparatus with synchronous light path delay according to claim 1, wherein the first moving module is an X-direction moving module and the second moving module is a Y-direction moving module.

3. The laser apparatus with synchronous light path delay according to claim 1, wherein the machining head has a third moving module which is movably connected to the second moving module, wherein the third moving module is a Z-direction moving module.

4. The laser apparatus with synchronous light path delay according to claim 1, wherein the machining head has a beam input end, at least one beam output end, and a switch device, wherein the at least one beam output end comprises a first beam output end and a second beam output end.

5. The laser apparatus with synchronous light path delay according to claim 1, wherein the second moving module is provided with a vision module.

6. The laser apparatus with synchronous light path delay according to claim 1, wherein the source reflection assembly comprises a first reflector, a second reflector, and a third reflector, wherein the first reflector is disposed corresponding to the laser source and the second reflector, wherein the second reflector and the third reflector are disposed corresponding to the return reflection assembly, wherein the third reflector is disposed corresponding to the moving reflector.

7. The laser apparatus with synchronous light path delay according to claim 4, wherein the return refection assembly, the first reflector, the second reflector, and the third reflector are reflecting mirrors.

8. The laser apparatus with synchronous light path delay according to claim 1, wherein the gantry-type machine and the laser path adjustment unit are connected to a control unit.

9. The laser apparatus with synchronous light path delay according to claim 1, wherein the total moving distance of the machining head induced by the movements of the first moving module and the second moving module, wherein the adjustment distance of the laser path adjustment unit is half of the total moving distance of the machining head.

10. The laser apparatus with synchronous light path delay according to claim 3, wherein a total moving distance of the machining head, which is defined by the movements of the first moving module, the second moving module, and the third moving module, wherein the adjustment distance of the laser path adjustment unit is half of the total moving distance of the machining head.
